(19) United States
(12) Patent Application Publication
(10) Pub. No.: US 2005/0003832 A1
(43) Pub. Date: Jan. 6, 2005

(54) Method for managing position information about nodes connected to a network

(75) Inventors: Tatsuaki Osafune, Fussa (JP); Akio Yoshimoto, Yokohama (JP); Susumu Matsui, Machida (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/808,923

(22) Filed: Mar. 24, 2004

(30) Foreign Application Priority Data
May 27, 2003 (JP) 2003-148492

(51) Int. Cl. H04Q 7/20

(52) U.S. Cl. 455/456.1

(57) ABSTRACT

A method for graphically indicating the positions of nodes connected to an ad hoc network is described. The method permits graphic display of the positions of the configured nodes including at least a node having a position-information detection device such as a GPS receiving device and a node having no such device for detecting its own position information, the graphic display being accomplished based on position information obtained by the detection device and on routing information about the node with no position-information detection device.

### CROSS-REFERENCE TO RELATED APPLICATION(S)

This application claims priority based on Japanese Patent Application, No. 2003-148492 filed on May 27, 2003, the entire contents of which are incorporated herein by reference.

### BACKGROUND OF THE INVENTION

This invention relates to a method for providing position information about nodes connected to a wireless communications network.

Advances in wireless communications technology have entailed a concomitant trend: widespread use of wireless communications environments in corporate offices and extensive distribution of wireless communications services in public places. Such wireless communications environments and services are typically implemented by wireless LAN access points through which existing networks are accessed for communications. Apart from that trend-, discussions about so-called ad hoc networks are being held by standardization-promoting bodies. The ad hoc network is a network made up of nodes communicating with one anther without the need for established communications infrastructure such as access points.

Generally, an ad hoc network is configured as a set of diverse nodes with wireless communications capabilities, such as PDAs (personal digital assistants), mobile phones, and laptop computers. The nodes can communicate with each other when they are located within a wireless communication distance of each other, i.e., where packet-carrying radio waves can propagate from one node to another. The nodes can also communicate with each another even if positioned so far apart that their radio waves fail to propagate directly between them. In such a case, each node need only repeat packets destined for another node.

Routing information needs to be exchanged on the other ad hoc network to repeat packets. Assume that three nodes, A, B and C, make up an ad hoc network; that nodes A and B can communicate directly with each other using their wireless communication functions; that nodes B and C can likewise communicate with each other by use of their wireless communication functions; and that nodes A and C are located beyond the range of direct wireless communication with each other by radio waves. In that case, if nodes A and C are to communicate with one another, they must be notified that node B is ready to repeat the radio waves. The notification is accomplished by node B informing nodes A and C that it can communicate with both of them, either periodically or on request by one of the two nodes. In this manner, routing information is exchanged over the ad hoc network, whereby the nodes beyond the range of direct radio communication with each other can still communicate.

An ad hoc network where routing information is periodically exchanged is called a proactive ad hoc network, whereas an ad hoc network where routing information is exchanged at the start of a data communication is called a reactive ad hoc network. On the proactive ad hoc network, each of the component nodes retains routing information, received in advance, designating the routes to each of the others preparatory to periodically exchanging routing information.

On the ad hoc network, it is possible to acquire routing information about the nodes communicating with each another, but not their physical positions. Still, the physical positions of the nodes need to be obtained in order to manage the network configuration and communication status. Once the physical positions of the nodes are known, any faulty node triggering a defective communication over the network can be isolated and repaired, so that the normal state of communication over the network can be restored.

A related position-information managing method is disclosed illustratively in Japanese Laid Open Patent Publication No. 2002-109679 proposing a position-information providing system. The proposed system involves configuring a routing network with physical means installed along routes. Nodes and terminal points constituting the routing network are each furnished with a communications unit permitting wireless communications access whereby tourists are offered information. More specifically, a plurality of wireless communication units are set up in a given area to detect the positions of tourists. The wireless communications units thus established transmit radio waves and receive responses from a data communications terminal owned by each tourist. The response from the tourist's terminal is detected and the position of that terminal is accordingly determined.

### BRIEF SUMMARY OF THE INVENTION

The system outlined above requires establishing a plurality of immutable wireless communications units for transmitting radio waves. The range in which the positions of the tourists' terminals can be detected is limited to the vicinities of the immutably located wireless communications units. The wider the range where position information is to be acquired, the larger the number of immutable wireless communications units that need to be set up. A major disadvantage of such a system is its increasing cost as its service area expands.

The present invention provides a position-information managing method for offering position information about nodes constituting an ad hoc network without recourse to immutably established wireless communications units. According to one aspect of the invention, a position-information managing method is provided for graphically displaying positions of a plurality of nodes connected to an ad hoc network. The method permits graphic display of the positions of at least a node having a position-information detection device such as a GPS (Global Positioning System) receiving device, a node with its position previously determined, and a node having no device for detecting its own-position information using the predetermined node-position information and/or position information obtained by the detection devices in use.

According to another aspect of the invention, a position-information managing method is provided for graphically displaying the position of any node having no device for detecting its own-position information, using routing information exchanged by the nodes connected to an ad hoc network. The routing information includes values called metrics representing logical distances between any two nodes. The metrics are typically generated by the number of hops. It is expected that the number of hops between a given node and a nearby node is small, while the hop count is proportionately larger between the node of interest and a distant node. By counting the number of hops, it is possible to estimate how far away a node having no position-information detection device is from another node equipped with a position-information detection device. The hop count thus obtained is used to graphically display the approximate position of any node with no position-information detection device.

As described, the inventive method for displaying the positions of nodes connected to a network permits graphic display, based on network routing information, of the configured nodes incapable of detecting their own device positions.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 shows a typical configuration of an ad hoc network to which a position-information managing method embodying the invention is applied;

FIG. 2 outlines a typical hardware structure of one of the PDAs in an ad hoc network;

FIG. 3 exemplifies a routing table created on the basis of routing information from the PDAs;

FIG. 4 is a flowchart of a routing information transmission process as part of the position-information managing method of the invention;

FIG. 5 illustrates a typical format of a packet transmitted by the routing information transmission process of the invention;

FIG. 6 is a flowchart of steps constituting a position-information displaying program as part of the position-information managing method of the invention;

FIG. 7 illustrates a typical format of a transmission request packet transmitted by the position-information displaying program of the invention;

FIG. 8 shows a position-information table created in a shared memory by the position-information displaying program of the invention;

FIG. 9 exemplifies a link information table created in shared memory by the position-information displaying program of the invention;

FIG. 10 illustrates a typical screen display obtained by the position-information displaying program of the invention; and

FIG. 11 depicts a typical hardware structure of a position-information display server of the invention.

### DETAILED DESCRIPTION OF THE INVENTION

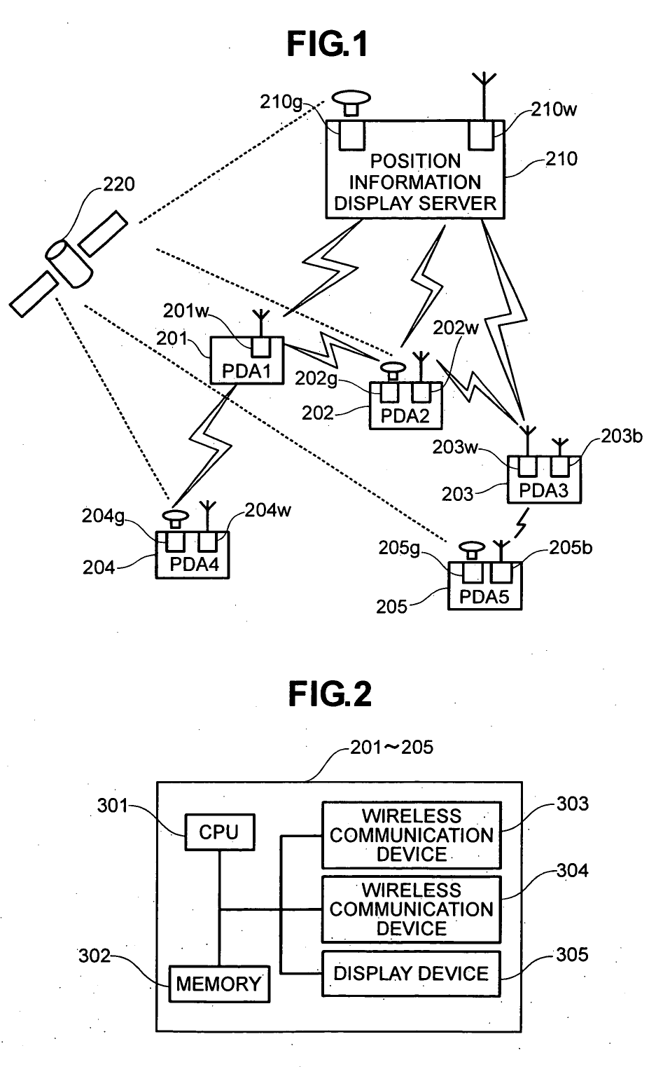

Preferred embodiments of this invention are now described with reference to the accompanying drawings. FIG. 1 shows a typical ad hoc network configuration to which this invention is applied.

In FIG. 1, PDA1 (201), PDA2 (202), PDA3 (203), PDA4 (204) and PDA5 (205) are nodes typically constituting personal digital assistants (PDAs) that each have a wireless communication device and that take part in an ad hoc network. A wireless LAN device 201 is connected to or incorporated in PDA1 (201). Likewise, wireless LAN devices 202w, 203w, and 204w are connected to or incorporated in PDA2 (202), PDA3 (203), and PDA4 (204), respectively. A short-distance wireless communications device 203b is connected to or incorporated in PDA3 (203). Similarly, a short-distance wireless communications device 205b is connected to or incorporated in PDA5 (205). A GPS receiving device 202g, connected to or incorporated in PDA2 (202), acquires geographical position information by receiving radio waves from GPS satellites. The same function is served by GPS receiving devices 205g and 205g, which are connected to or incorporated in PDA4 (204) and PDA5 (205), respectively. Position information display server equipment 210 (hereafter called position information display server 210), connects to or incorporates a wireless LAN device 210w and a GPS receiving device 210g. A plurality of GPS satellites 220 transmit GPS signals.

In the configuration above, PDA1 (201) can communicate directly with PDA2 (202) using wireless LAN device 201w. Similarly, direct wireless communication can be effected between PDA1 (201) and PDA4 (204), between PDA1 (201) and position-information display server 210, between PDA2 (202) and PDA3 (203), between PDA2 (202) and position-information display server 210, and between PDA3 (203) and position-information display server 210 by use of their respective wireless LAN devices. Direct wireless communication is also executed between PDA3 (203) and PDA5 (205) using their short-distance wireless communications devices. GPS receiving devices 202g, 204g, 205g, and 210g are capable of receiving GPS signals for determining geographical positions from a plurality of GPS satellites 220.

FIG. 2 shows the typical internal structure of PDA 201 through 205. As indicated, each PDA comprises a CPU 301, a memory 302, wireless communications devices 303 and 304, and a display device 305 interconnected by internal communications lines (i.e., a bus). Each of wireless communications devices 303 and 304 represents any one of a wireless LAN device, a GPS receiving device, and a short-distance wireless communications device. Alternatively, only one of the three communications devices may be used by the PDA.

FIG. 11 shows a typical internal structure of position-information display server 210. Position-information display server 210 includes a CPU 1201, a memory 1202, wireless communications devices 1203 and 1204, and a video card 1205 interconnected by internal communications lines (i.e., a bus). Each of wireless communications devices 1203 and 1204 stands for any one of a wireless LAN device, a GPS receiving device, and a short-distance wireless communications device. Alternatively, only one of the three communications devices may be used by position-information display server 210. Video card 1205 is connected to a display 1206 in a wired or wireless fashion.

In the description that follows, the processes performed by the configured devices are, in fact, carried out by the CPU of each device using programs held in the memory of the device in question. The programs may be either pre-stored in the memories or loaded into the memories, as needed, by use of a detachable, device-compatible storage medium or by data transfers over a network.

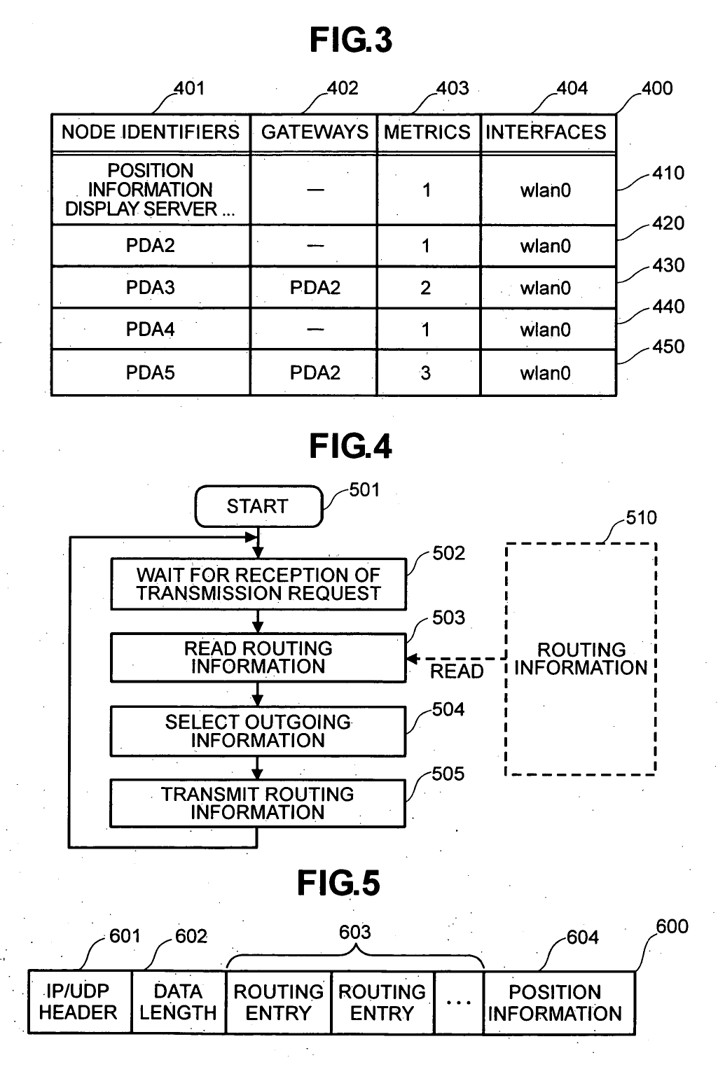

FIG. 3 is a tabular view of part of the routing information held in the memory of PDA1 (201) following an exchange of routing information among the nodes on the network of FIG. 1. More specifically, FIG. 3 exemplifies a routing table 400 generated from the routing information. FIG. 3 shows typical communications routes to be taken by PDA1 (201) in communicating with the other nodes. The first column lists an identifier 401 for each node communicating with PDA1 (201). Each node identifier 401 is composed of an IP address of the node in question or of a node name corresponding to an IP address determined by the IP address of the node and by the DNS (Domain Name System). The second column contains a gateway 402 to be taken by each node forwarding a packet to the next node so that the packet will reach the node identified by node identifier 401. Each gateway 402 is also composed of an IP address of the node in question or of a node name corresponding to an IP address determined by the IP address of the node and by the DNS (Domain Name System). Where there are no records in the gateway fields 402 (e.g., 410, 420 and 440 in FIG. 3), that means each of the corresponding nodes can communicate directly with PDA1 (201). The third column shows values representing logical distances 403 (i.e., metrics) between any two nodes identified by node identifiers 401. In this example, the metrics are represented by the number of hops between the nodes. The fourth column lists a device acting as an interface 404 through which a packet can be sent to the target node identified by node identifier 401. Each interface field 404 holds the identifier of any one of the wireless communications devices contained in PDA1 (201).

In FIG. 3, a routing entry 410 allows PDA1 (201) to communicate with position-information display server 210. In entry 410, position-information display server 210 is designated as node identifier 401; nothing is designated as gateway 402; a value 1 is designated as metric 403; and wlan0 is designated as the interface 404. Interface wlan0 stands for wireless LAN device 201w inside PDA1 (201). In the routing entry 420, PDA2 is designated as node identifier 401; nothing is designated as gateway 402; the value 1 is designated as metric 403; and wlan0 is designated as interface 404. In routing entry 430, PDA3 is designated as node identifier 401; PDA2 is designated as gateway 402; a value 2 is designated as metric 403; and wlan0 is designated as interface 404. In routing entry 440, PDA4 is designated as node identifier 401; nothing is designated as gateway 402; a value 1 is designated as metric 403; and wlan0 is designated as interface 404. In routing entry 450, PDA5 is designated as node identifier 401; PDA2 is designated as gateway 402; a value 3 is designated as metric 403; and wlan0 is designated as interface 404.

From routing table 400 in FIG. 3, it can be understood that PDA1 (201) can communicate directly with position-information display server 210, PDA2 (202), and PDA4 (204), and that PDA1 (201) may communicate via PDA2 (202) with PDA3 (203) and PDA5 (205).

How position-information is graphically displayed on the basis of information coming directly from communicable nodes is described below with reference to routing table 400.

FIG. 4 is a flowchart of steps constituting a routing information transmission process of this invention. This process is carried out individually by each of the nodes shown in FIG. 1, i.e., PDA1 (201), PDA2 (202), PDA3 (203), PDA4 (204), PDA5 (205), and position-information display server 210.

After starting the process (in step 501), the node waits for the reception of a request to transmit routing information (in step 502). Upon receipt of the transmission request, the node reads the routing information to be retained by this node (in step 503). The routing information 510 to be read at this point is made up of the data in routing table 400. Alternatively, some other routing information generated by an ad hoc routing process may be used.

After routing table 400 is read, outgoing information is selected (in step 504). At this point, position-information display server 210 is used to select the information needed to display position information graphically. For graphic position display, this embodiment utilizes information from the directly communicable nodes (with a hop count of 1 each). Specifically, a search is made through routing table 400 for the routing entries with no records of gateway 402, i.e., for routing entries 410, 420 and 440 corresponding to the nodes directly communicable with this node.

Alternatively, the nodes with a hop count of 1 each may be supplemented by the nodes with a hop count of 2 or more each for graphic position display. In this case, routing entries 430 and 450 are additionally selected.

The selected routing entries are transmitted to position-information display server 210 (in step 505). The information transmitted at this point is schematically shown in FIG. 5. If this node is in possession of its own-position-information measuring device and has its position information measured by this device, measured position information 604 is transmitted. Any node without its own-position-information measuring device does not transmit position information 604.

After transmitting the routing information (in step 505), the node waits for the reception of another transmission request that may come from position-information display server 210 (in step 502). On receipt of the transmission request from server 210, the node reaches step 503 again to read the routing information, and repeats the subsequent steps.

FIG. 5 shows a typical format of a packet 600 transmitted to position-information display server 210 in step 505. Packet 600 is headed by an IP/UDP header 601 followed by a data length field 602. On receiving the packet 600, position-information display server 210 references the data length inside to determine the number of routing entries contained in the packet, as will be discussed later.

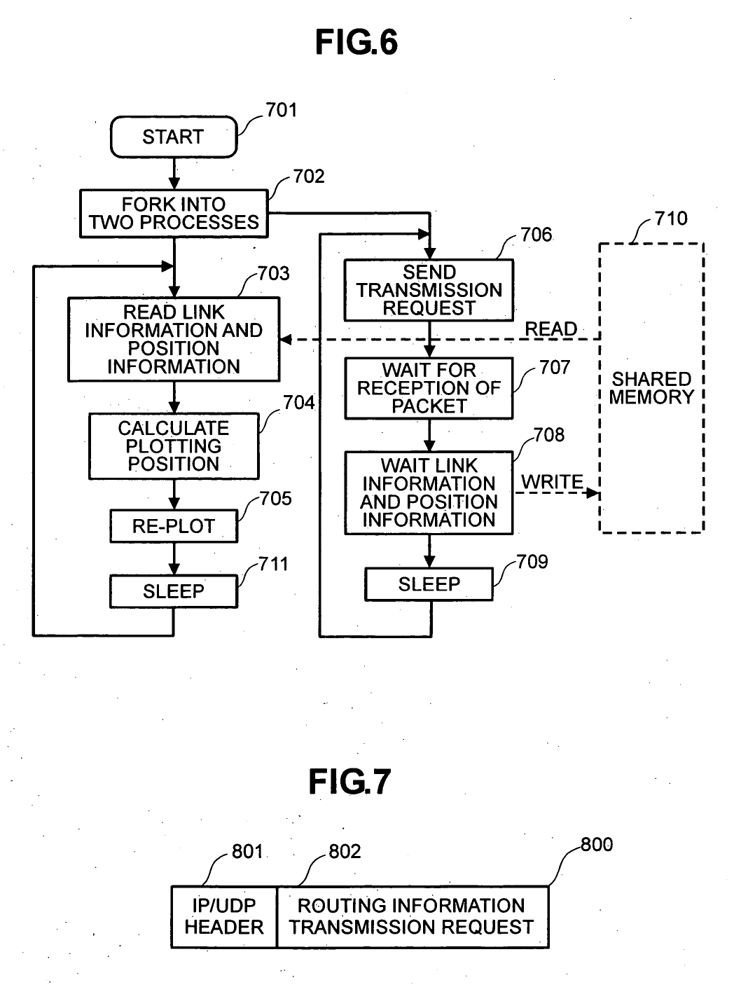

FIG. 6 is a flowchart of steps constituting a program carried out by position-information display server 210. The program is capable of receiving the packet shown in FIG. 5 and of plotting the received packet. The program is started by a start request made by a user (in step 701). The activated program forks into two processes (in step 702): one for receiving routing information from each node; the other for graphically displaying position information.

In the process for receiving routing information from the nodes, the program first sends a routing information transmission request to each node (in step 706). The nodes to which to send the transmission request are all nodes that are found to take part in an ad hoc network by a search through routing table 400 of server 210. The search through routing table 400 picks up all nodes that constitute the ad hoc network, so that the nodes may be notified of the request to transmit their routing information.

FIG. 7 shows a typical packet format 800 of the transmission request. This packet is made up of an IP/UDP header 801 and a routing-information transmission request 802. R-information transmission request 802 specifies that this packet be sent by position-information display server 210 and constitutes a request asking the receiving node to transmit its routing information. Each node that has received this request transmits packet 600 shown in FIG. 5 to position-information display server 210.

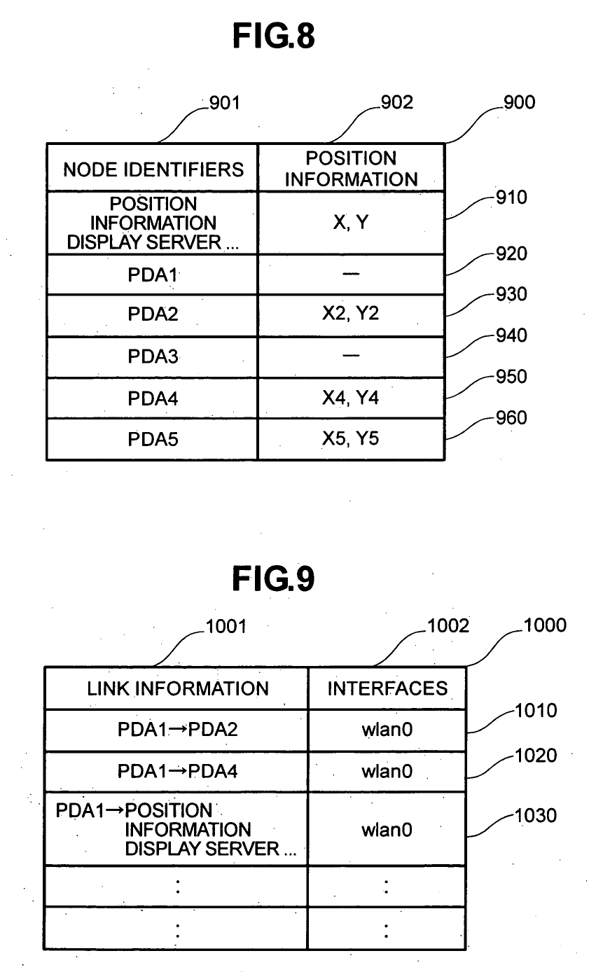

After sending the transmission request (in step 706), position-information display server 210 waits for the reception of a packet 600 from each node (in step 707). After receiving packet 600 from the nodes, position-information display server 210 writes information based on the routing entries (i.e., link information) from each node to a link information table 1000 shown in FIG. 9, and writes information based on the position information shown in FIG. 5 to a position-information table 900 shown in FIG. 8 (in step 708). These table contents are written to a shared memory 710.

Shared memory 710 is formed by an area in memory 302 to and from which routing information can be written and read, respectively, by the routing information receiving process and the position-information displaying process. After the link information is written, the routing information receiving process remains in a sleep state for a predetermined time period (in step 709). The sleep time is established and handed over as an argument to this program upon program activation. At the end of the predetermined sleep time period, the process returns to step 706 and repeats the subsequent steps.

The position-information displaying process is carried out in parallel with process of steps 706 through 709 above.

In the position-information displaying process, link information and position information are first read from shared memory 710 (in step 703). The read operation provides the routing information from the nodes capable of detecting their own positions and the information from the nodes with which the node in question can communicate directly. For example, in the network configuration of FIG. 1, PDA2 (202) can acquire its own position information and can communicate directly with PDA1 (201), PDA3 (203) and position-information display server 210. Position information from the nodes that are incapable of detecting their own positions is not available, but information is acquired about which node can communicate directly with each of these nodes. Illustratively, in the network configuration of FIG. 1, PDA1 (201) cannot obtain its own position information but is capable of communicating directly with PDA2 (202), PDA4 (204) and position-information display server 210.

The above pieces of information are used as the basis for calculating plotting positions. First of all, the plotting positions of the nodes that have transmitted their position information are determined. FIG. 8 shows a position-information table 900 created in the shared memory on the basis of the information received from the nodes. Position-information table 900 includes node identifiers 901 and position information 902 corresponding to the identifiers. A record 910 contains position information (X, Y) about position-information display server 210. Likewise, records 930, 950 and 960 contain position information (X2, Y2), (X4, Y4) and (X5, Y5) about PDA2 (202), PDA4 (204) and PDA5 (205), respectively. A record 920 contains a node identifier PDA1 (201) but not position information 902 because PDA1 (201) is incapable of detecting its own position and does not send position information to position-information display server 210. Similarly, a record 940 does not contain position information 902 because applicable PDA3 (203) is incapable of detecting its own position.

In step 704, plotting positions are calculated using a maximum (Mx) and a minimum (mx) value of the X-axis coordinates as well as a maximum (My) and a minimum (my) value of the Y-axis coordinates. For example, suppose that all nodes, each with its position information written in the position-information table, are plotted with lengthwise and crosswise margins of 20 percent regarding a screen size (Sx, Sy). In that case, the plotting position (Px, Py) of the position information (Gx, Gy) is calculated using the following expressions:
Px=[0.2+(1-0.2×2){(Gxmx)/(Mxmx)}]×Sx
Py=[0.2+(1-0.2×2){(Gymy)/(Mymy)}]×Sy

Then, based on the link information, the plotting position of any node that has not sent its position information is determined. As can be seen in FIG. 8, PDA1 (201) and PDA3 (203) do not have their position information, so that they need to have their plotting positions calculated. Illustratively, the plotting position calculation is performed in keeping with three rules: (1) the initial values of the plotting position are randomly determined; (2) the directly communicable nodes (with a hop count of 1 each) supposedly located close to each another, exert gravitational attraction on each other so that their plotting positions become closer in proportion to distance; and (3) all nodes repel one another so that their plotting positions shift away from one another in inverse proportion to distance. The concept of the force of repulsion between nodes is introduced here to avoid a situation where gravitational attraction between the nodes shifts them too close to each other to be clearly distinguished on display.

Suppose now that the plotting position of PDA1 (201) is calculated. It is assumed that the current plotting position of PDA1 (201) is (Px1, Py1) and that of PDA2 (202) is (Px2, Py2). The amount of plotting position shift by repulsion (dxr, dyr) and the amount of plotting position shift by attraction (dxa, dya) are calculated using the following expressions:
dxr=R(Px1−Px2)/L×L
dyr=R(Py1−Py2)/L×L
where, R denotes a given positive number and L represents the distance between the plotting positions of PDA1 and PDA2. The amount of plotting position shift by repulsion regarding each of the other nodes, i.e., PDA3 (203), PDA4 (204), PDA5 (205), and position-information display server 210, is likewise calculated.

Where the force of attraction is to be calculated, the directly communicable nodes are determined by referencing the link information table 1000 of FIG. 9. In FIG. 9, shows link information 1001 written to shared memory 710 (in step 708) for link information registration, and interfaces 1002. A record 1010 indicating that PDA1 (201) can communicate directly with PDA2 (202 is shown in the interfaces column; a record 1020 indicates that PDA1 (201) can communicate directly with PDA4 (204); and a record 1030 indicates that PDA1 (201) can communicate directly with PDA4 (204). Records 1010, 1020 and 1030 indicate that direct communication from the PDA to the respective nodes is effected through the interface wlan0. From these records, it is understood that the amount of shift by attraction for PDA1 (201) may be calculated with respect to PDA2 (202), PDA4 (204), and position-information display server 210. The amount of shift by attraction for PDA1 (201) regarding direct communication with PDA2 is calculated using the following expressions:
dxa=A(Px2−Px1)
dya=A(Py2−Py1)
where A stands for a given positive number. The amount of shift by attraction with regard to the other directly communicable nodes, i.e., PDA4 and position-information display server 210, is similarly calculated. In calculating the amount of shift by attraction, more accurate plotting is accomplished by varying coefficient A depending on interface information 404 in routing table 400. For example, if the interface is a short-distance wireless communications device, the directly communicable node is expected to be very close to this node because short-distance wireless communications generally take place over distances much shorter than those with wireless LAN devices. Coefficient A is thus increased regarding the interface of short-distance wireless communication and decreased for the interface of longer wireless communication distances. The result is plotting much closer to reality than before, carried out by position-information display server 210.

In calculating the amount of shift by attraction, information between the nodes with a hop count of 2 or more each may be used as mentioned earlier. In that case, coefficient A is varied depending on the hop count so that the forces of attraction between the nodes may be added up in calculating the amount of plotting position shift regarding each node.

The amount of plotting-position shift for PDA1 (201) is calculated by adding up the amounts of shift by repulsion and the amounts of shift by attraction involved. If the sum total of the amounts of plotting-position shift is represented by (dxsum, dysum), then the new plotting position (Px1new, Px2new) of PDA1 (201) is calculated using the following expression:
Px1new=Px+dxsum
Py1new=Py+dysum

The calculations above are performed on each of the other nodes not in possession of their position information.

Finally, re-plotting is carried out (in step 705) based on the newly obtained plotting positions, and a sleep state is entered and maintained for a predetermined time (in step 711). Thereafter, this process returns to the step of reading link information and position information (step 703), and repeats the subsequent steps.

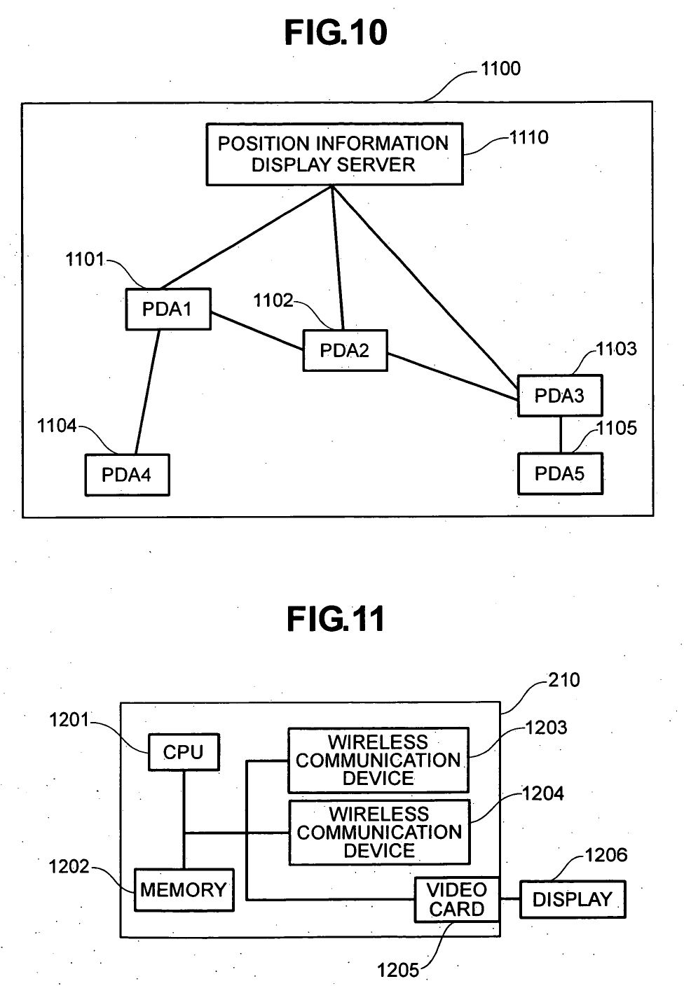

Given the results of the process above, video card 1205 of position information display server 210 displays the positions of the nodes involved on display 1206. FIG. 10 shows a typical display screen image 1100. The display screen shows not only the positions of the nodes but also lines connecting each node with other nodes indicating whether the node in question can communicate directly with any other node.

Through the use of the inventive position-information managing method, each node having a position-information detecting device such as a GPS (Global Position System) receiver, i.e., PDA2 (202), PDA4 (204), PDA5(205), and position information-display server 210, have their positions displayed in screen image 1100 on the basis of the position information shown as devices 1102, 1104, 1105 and 1110 representing the nodes. Nodes PDA1 (201) and PDA3 (203) incapable of detecting their own positions may also have their positions plotted as devices 1101 and 1103 representing the nodes by use of the routing information from the ad hoc network.

It should be noted that this invention applies not only to the proactive ad hoc network discussed above but also to reactive ad hoc networks.

The specification and drawings are, accordingly, to be regarded in an illustrative rather than a restrictive sense. It will, however, be evident to those skilled in the art that various modifications and changes may be made thereto without departing from the spirit and scope of the invention as set forth in the claims.

1. A position-information managing method for managing positions of a plurality of nodes connected to a network, the method permitting calculation of position information about any one of the nodes not furnished with any own-position detection unit by use of network routing information for allowing the nodes to communicate with one another, position information about any one of the nodes which has an own-position detection unit, and/or position information about any one of the nodes which has a predetermined position.

2. A position-information managing method according to claim 1, wherein the method permits display of the positions of the plurality of nodes by use of the position information about the node having the own-position detection unit, the position information about the node with the predetermined position, and the calculated position information.

3. A position-information managing method according to claim 2, wherein the network routing information includes distance information about logical distances between each of the plurality of nodes and the other nodes, and wherein the method permits calculation of the position information about the node with no own-position detection unit in accordance with the logical distance information.

4. A position-information managing method according to claim 3, wherein the logical distance information is constituted by the number of hops.

5. A position-information managing method according to claim 3, wherein the position information about the node with no own-position detection unit is calculated using as a coefficient the distance over which a wireless communications unit of the node in question can communicate directly with any other node.

6. A position-information managing method according to claim 3, wherein the positions of the nodes are displayed together with lines connecting any two nodes that can communicate directly with each other.

7. A network system having a plurality of nodes connected via a network, the system comprising a connection-configuration display server having a unit for graphically indicating positions of the plurality of nodes;
wherein the plurality of nodes are constituted at least by a node having an own-position detection unit and/or a node having a predetermined position, and by a node with no own-position detection unit; and
wherein the connection-configuration display server calculates position information about the node with no own-position detection unit by use of network routing information for allowing the plurality of nodes to communicate with one another, position information about the node having the own-position detection unit, and/or position information about the node having the predetermined position, the connection-configuration display server further displaying positions of the plurality of nodes based on the calculated position information.

8. A network system according to claim 7, wherein the connection-configuration display server when displaying the positions of the nodes indicates lines connecting any two nodes that can communicate directly with each other.

9. A network system according to claim 8, wherein each of the plurality of nodes transmits network routing information owned by the node in question to the connection-configuration display server; and
wherein the connection-configuration display server receives the network routing information from the plurality of nodes.

10. A network system according to claim 9, wherein any one of the plurality of nodes which has the own-position detection unit transmits the position information acquired by the unit to the connection-configuration display server; and
wherein the connection-configuration display server receives the network routing information and the acquired position information.
